(19) United States
(12) Patent Application Publication
(10) Pub. No.: US 2008/0299854 A1
(43) Pub. Date: Dec. 4, 2008

(54) Flame Resistant Spacer Fabric

(75) Inventors: Scott N. Hilleary, Spring City, TN (US); Howard Scroggins, Grandview, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SSM Industries, Inc.

(21) Appl. No.: 11/756,850

(22) Filed: Jun. 1, 2007

(51) Int. Cl. B32B 5/02; D02J 1/00; D04B 1/00

(52) U.S. Cl. 442/136; 264/103; 442/314

(57) ABSTRACT

The present invention provides a heat resistant spacer fabric comprising a first and second fabric layers that are formed of a flame resistant material arranged in opposing face-to-face relation and are spaced apart from each other. The first and second fabric layers are interconnected to each other with one or more spacer fibers that interconnect the first and second fabric layers and define a space therebetween. The spacer fibers comprise at least one core fiber having one or more wrap fibers of a flame resistant material wrapped thereabout. The wrap fibers protect the core fibers from direct contact with heat and flame. If the spacer fabric is exposed to heat/flame, the flame resistant wrap fibers help to prevent any melted material of the core fibers from flowing out of the spacer fabric. The spacer fabric can be used in protective garments such as coats, gloves, pants, cover-alls, suits, etc.

### FIELD OF THE INVENTION

The present invention relates generally to heat and flame resistant fabrics and more particularly to a flame resistant spacer fabric.

### BACKGROUND OF THE INVENTION

Many workers, such as firemen, industrial workers, forest fire fighters, race car drivers and airplane pilots, have occupations that may expose them to environments and situations involving extreme heat and fire. In such environments and/or situations, safety is a paramount concern. Working in and around environments wherein one is exposed to extreme heat and fire continually subjects workers to risks of being seriously burned or overcome by heat exposure, which can cause heart attacks, strokes, dehydration and other injuries that very well can be fatal. Accordingly, it is necessary to provide protective garments having a high degree of heat and fire resistance.

To provide protection against heat and fire, protective garments, such as firefighter's turnout coats, trousers, jackets, gloves, boots, hats, head coverings, masks, etc. have been developed that comprise fabrics formed of flame resistant materials. Generally, these flame resistant fabrics comprise multilayers of fabric that are formed of flame resistant yarns that can be thick, heavy, and stiff. As a result, the protective garments can also be relatively heavy, bulky and somewhat inflexible.

The weight of flame resistant garments contributes to the stress to which the wearers are subjected, as the heavier the garment the more exertion that is required from the wearer to move and work in the garment. In general, manufacturers of flame resistant garments have tried to strike a balance between providing a high a degree of flame and heat resistance protection while limiting the weight of such a garment so that a worker can maintain an adequate level of mobility.

Further, while such conventional flame and heat or thermal resistant fabrics generally have been adequate for protecting workers against exposure to fire and extreme heat, the stiffness and general inflexibility of such fabrics tends to cause another significant problem, which is the restriction of freedom of movement of a worker while wearing garments made from such fabrics. By restricting the freedom of movement of the wearer, further stress is placed upon and greater exertion is required from the wearer in order to move and work in the protective garments. This increased exertion further increases the risk of injury to the worker.

Thus, there still exists a need for a flame resistant fabric that is relatively lightweight and flexible, while still providing adequate protection from heat and flame.

### BRIEF SUMMARY OF THE INVENTION

The present invention provides a heat resistant spacer fabric that helps overcome many of the problems associated with previous flame resistant fabrics. In particular, the present invention provides a flame resistant spacer fabric comprising at least a first and second fabric layers that are formed of a flame resistant material and are arranged in an opposing back-to-back, spaced apart relationship with each other. The first and second fabric layers are interconnected to each other with one or more spacer fibers that interconnect the first and second fabric layers and define a space therebetween. The spacer fibers comprise a resilient material that is able to maintain the space between the fabric layers, while still permitting the layers to be reversibly compressed together. As a result, the spacer fabric provides a relatively light weight and flexible fabric, while maintaining adequate protection to the wearer from heat and flame.

The spacer fibers comprise at least one core fiber having one or more wrap fibers of a flame resistant material wrapped thereabout. The core fibers generally comprise a resilient material that is capable of maintaining the space between the first and second fabric layers. Generally, the core fibers comprise a material that may not have a desired level of flame resistance. To protect the core fibers from direct contact with heat and flame, one or more flame resistant wrap fibers are wrapped about the cores fibers to substantially surround and encapsulate the core fiber. The wrapping of the flame resistant wrap fibers about the core fiber forms a protective sheath or covering about the core fibers. If the spacer fabric is exposed to heat/flame that is in excess of the core fiber's melting temperature, the flame resistant wrap fibers help to prevent the melted material of the core fibers from flowing out of the spacer fabric. This may be particularly useful in flame resistant articles, such as coats, pants, gloves, head coverings, race car driver jump suits, etc. where the spacer fabric may be in close proximity to the wearer.

In one embodiment, the wrap fibers and the first and second fabric layers comprise a flame resistant material that is able to withstand elevated temperatures. Suitable flame resistant materials for the wrap fibers and first and second fabric layers may include aramids, flame resistant polynosic rayon, flame resistant cotton, flame resistant polyester, polybenzimidazole, polyvinyl alcohol, polytetrafluoroethylene, flame resistant wool, poly(vinyl chloride), polyetheretherketone, polyetherimide, polyethersulfone, polychlal, polyimide, polyamide, polyimide-amide, polyolefin, polybenzoxazole, flame resistant acetone, carbon, graphite modacrylic, acrylic, melamine, polyoxodiazole and combinations thereof.

In one embodiment, the first and second fabric layers may comprise a warp pile fabric in which one set of fibers (e.g., warp fibers) interlace with a second set of fibers (e.g., filling fibers) to form the fabric. In this embodiment, the spacer fabric of the invention can be prepared in a double weave process in which the spacer fibers are interlaced with one set of warp fibers and one set of filling fibers which form the first fabric layer. The spacer fibers are then interlaced with a second set of warp fibers and filling fibers to form the second fabric layer. The spacer fibers interconnect the first and second fabric layers together and define the space therebetween.

Thus, the present invention provides a flame resistant spacer fabric that is flexible and relatively lightweight, while still maintaining adequate heat and flame resistance.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a flame and heat or thermal resistant spacer fabric that is in accordance with the invention;

FIG. 2A is a perspective view of a spacer fiber that can be used in the construction of the spacer fabric depicted in FIG. 1;

FIG. 2B is a perspective view of an alternative embodiment of a spacer fiber that can be used in the construction of the spacer fabric depicted in FIG. 1;

FIG. 3 is an illustration of a protective garment utilizing the spacer fabric depicted in FIG. 1.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

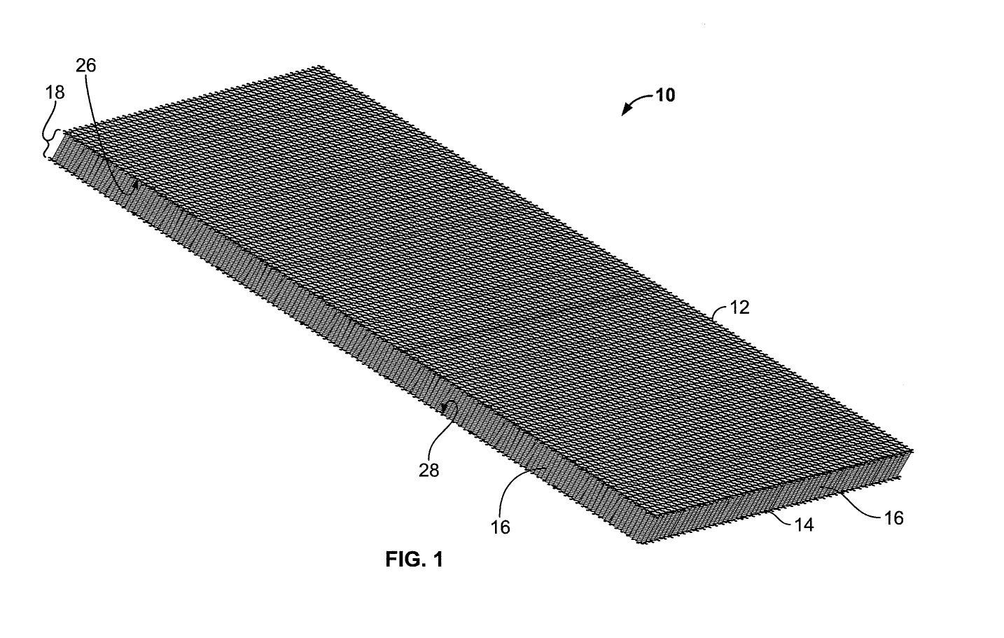

With reference to FIG. 1, a flame resistant spacer fabric in accordance with the invention is illustrated and broadly designated by reference number 10. As shown, spacer fabric 10 includes a first fabric layer 12 and a second fabric layer 14 that are disposed opposite each other in a back-to-back relationship and are spaced-apart from each other to form a three dimensional fabric. The spacer fabric includes one or more spacer fibers 16 interconnecting two or more fabric layers and defining a space 18 therebetween. The one or more spacer fibers are integrated with and extend between the first and second fabric layers so that the first and second fabric layers are maintained in a spaced apart parallel relation, while still permitting the layers to be reversibly compressible towards each other.

Although the illustrated embodiment, shows only two fabric layers, it should be recognized that the spacer fabric can include three or more fabric layers that are each interconnected to an adjacent fabric layers with one or more spacer fibers. For example, the spacer fabric can include a three-layered structure in which an interior fabric layer is interconnected to two opposing outer fabric layers with one or more spacer fibers to define a spacer fabric having a space disposed on opposite sides of the interior fabric layer.

In some embodiments, the space 18 between the first and second fabric layers can help improve the thermal insulating properties of the spacer fabric. For example, the space in the spacer fabric can be used to prevent heat from ingressing into the interior surface of the fabric as well as preventing heat, such as body heat, from escaping out of the fabric. As a result, the spacer fabric can be used to prepare articles that provide insulating properties for exposure to both heat and cold. Further, the space within the fabric layer may permit the overall weight of the spacer fabric to be reduced, while still maintaining a desired level of heat and flame resistance and insulating properties. Further, the resiliently compressible nature of the spacer fabric provides improvements in flexibility, reduction in bulk, and overall improvements in comfort to the wearer.

The distance between the first and second fabric layers can be selected based on the desired properties of the resulting spacer fabric, for example, flame resistance, resiliency, bulk, stiffness, compressibility, softness, liveliness, flexibility, drapeability, comfort, and the like. Further, the distance between the first and second fabric layers can also be selected based, at least in part, on the intended use of the spacer fabric. For example, in apparel and protective garment applications the distance between the first and second fabric layers may range from about 1 mm to 80 mm, and in particular from about 2 mm to 25 mm, and more particularly, from about 4 to 10 mm. In some embodiments, the distance between the first and second fabric layers is between about 2 to 10 mm, and in particular between about 3 to 8 mm. In other embodiments, such as structural or industrial applications, the distance between the first and second fabric layers can be greater than 75 mm, and in particular, greater than 150 mm. It should be understood that the spacing distance between the first and second layers is not limited to any particular distance provided that the spacer fabric maintains the desired properties.

The basis weight of the spacer fabric may also be selected based on the intended use and desired properties of the fabric. In apparel and protective garment applications, the basis weight of the spacer fabric may range from about 4.5 to 20 ozs./yd², and in particular from about 6 to 18 ozs./yd². In structural and industrial applications, the spacer fabric may have a higher basis weight, such as from about 6 to 50 ozs./yd², and in particular from about 8 to 40 ozs./yd².

The orientation of the spacer fibers with respect to the opposing inner surfaces of the first and second fabric layers is generally selected so that the spacer fibers are capable of reversibly maintaining the space between the first and second fabric layers. For example, the angle between the spacer fibers and the inner surfaces of the first and second fabric layers can generally vary between about 30° and 150°, with an average angle of about 45° to 135° between somewhat more typical. In the embodiment illustrated in FIG. 1, the spacer fibers 16 are generally oriented so that they are about 90° with respect to the inner surfaces 26, 28 of the first and second fabric layers 12, 14, respectively.

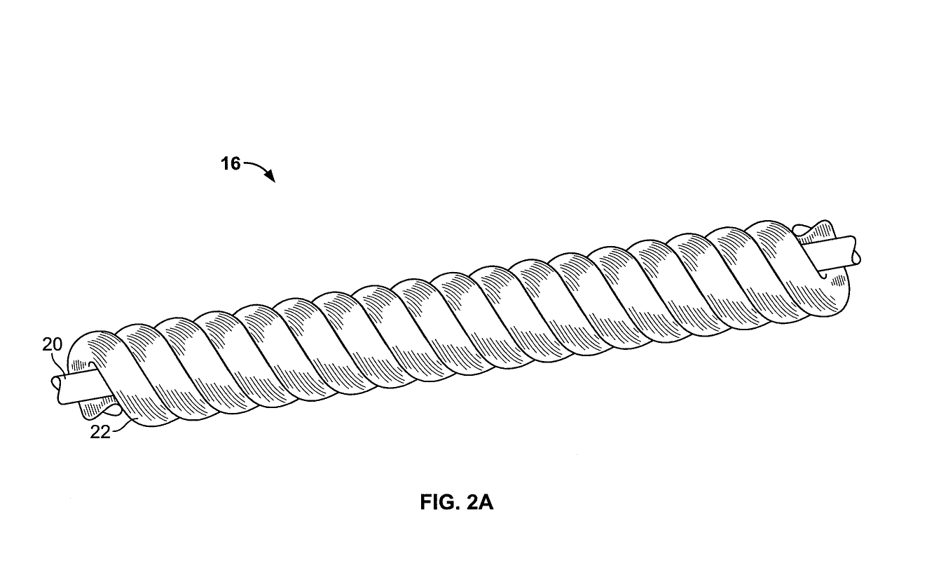

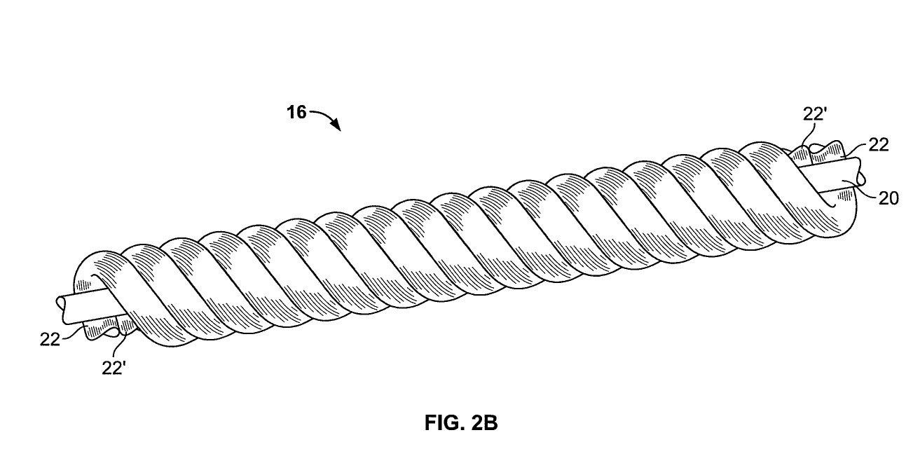

As can best be seen in FIG. 2, spacer fiber 16 includes at least one core fiber 20 about which one or more wrap fibers 22 are wrapped. Generally, the core fiber comprises a material having sufficient resilience and stiffness so that the space between the two fabric layers is maintained when the spacer fabric is in an uncompressed state. In one embodiment, the core fiber may be made of a resilient material such as monofilament or multifilament fiber. In particular, the use of monofilament fibers has been shown to enhance the desirable characteristics of compressibility and resiliency in the spacer fabric. Suitable materials for the core fiber may include polyester, nylon, acrylic, polypropylene, and the like. It should be understood that the term fiber is used in its generic sense and may include fibers, filaments, yarns, and the like.

The wrap fiber comprises a flame resistant material that is capable of withstanding elevated temperatures and/or flames without melting or catching fire. The wrap fiber surrounds the core fiber so that the core fiber is substantially encapsulated within the wrap fiber. The wrapping of the flame resistant wrap fibers about the core fiber forms a protective sheath or covering about the core fibers. Generally, the material comprising the core fibers is selected based on the desired resiliency of fibers and the ability of the fibers to maintain the spaced-apart relation between the first and second fabric layers. Typically, such fibers are selected based on a desired resiliency and may not have a desired level of flame resistance. Since the core fibers generally have a lower resistance to heat and fire than the wrap fibers and tend to degrade or melt from exposure to extreme temperatures and fire, the wrap fibers protect the core fiber from direct exposure to heat and flame and may prevent melting of the core fiber in some situations.

In the event the spacer fabric is exposed to heat/flame that is in excess of the core fiber's melting temperature, the flame resistant wrap fibers help to prevent the melted material of the core fibers from flowing out of the spacer fabric. This may be particularly useful in flame resistant articles, such as coats, pants, gloves, head coverings, race car driver jump suits, etc. where the spacer fabric may be in close proximity to the wearer. With conventional spacer fabrics, a melted core fiber can cause melt burns that can be more damaging to the wearer than the initial heat source due to the enduring heat of the molten polymer and its proximity to the skin of the wearer. The spacer fibers can comprise a core spun fiber that is prepared using conventional methods such as ring spinning, rotor spinning, air jet spinning, and the like.

The wrap fibers are wrapped tightly about the core yarn at about 20 to 60 turns per inch, and in particular, about 25 to 30 turns per inch. It also is possible for the wrap fibers to be wrapped about the core fibers in fewer or greater turns per inch as desired as long as the wrap fiber covers the core fibers to prevent exposure of the core fibers to heat and flame. The number of wraps generally depends on the size of the wrap fibers as the larger the wrap fiber, the fewer wraps or twists per inch are needed to ensure complete coverage. Further, the number of turns per inch may also be dictated by the desired characteristics of the resulting spacer fabric, such as the characteristics discussed above. In some embodiments, two or more wrap fibers may be wrapped about the core fiber in a side-by-side relationship. In this regard, FIG. 2B illustrates an embodiment wherein two wrap fibers 22, 22′ are wrapped about a core fiber 20 in a side-by-side relation with respect to each other. In the illustrated embodiment, the two wrap fibers are shown as being wrapped about the core fiber in the same direction (e.g., clock wise). In other embodiments, the wrap fibers can be wrapped in opposite directions with respect to each other, such as a counter-wrap orientation. In a further embodiment, two or more layers of wrap fibers can be wrapped about a core fiber to produce a multi-layered spacer fiber. Use of multiple layers can be used to further enhance the ability of the wrap fibers to contain molten material from the core fibers within the spacer fiber structure. In addition, the wrap fibers in such a multilayered spacer thread can be comprised of the same or a different composition with respect to each other.

The size of the core fibers is typically from about 15 to 300 denier, and in particular from about 15 to 100 denier. The size of the wraps fibers in typically from about 20 to 400 denier, and in particular from about 50 to 100 denier. Generally, the spacer fibers have a size that is from about 30 to 500 denier, and in particular from about 70 to 200 denier. In one particular embodiment, the spacer fibers have a size that is about 167 denier and are comprised of two wrap fibers that each have a size that is about 50 denier and a core fiber having a size that is about 30 denier.

The first and second fabric layers can comprise a woven, knit or nonwoven fabric. The first and second fabric can be woven using a variety of different weaving techniques, such as plain weaving, twill weaving, satin weaving, leno weaving, pile weaving, etc. In one particular embodiment, the first and second fabric layers can comprise a woven fabric comprising a series of longitudinally extending fibers (e.g., warp fibers or yarns) and a series of laterally extending fibers (e.g., filling or weft fibers or yarns). Generally, the longitudinal and lateral fibers are interwoven to form a lattice-like structure. As noted above, the fibers comprising the first and second fabric layer comprise a flame resistant material so that the resulting fabric layers are also flame resistant. The fibers comprising the first and second fabric layers may be the same or different from each other. Further, the longitudinal and lateral fibers may be the same or different from each other.

In one embodiment, the fabric layers (e.g., the first and second fabric layers) comprise a warp pile fabric in which one set of fibers (e.g., warp fibers) interlace with a second set of fibers (e.g., filling fibers) to form the fabric. Representative methods of forming warp pile fabrics include wire-cut pile, looped pile, and double weave. As discussed in greater detail below, the spacer fabric of the invention can be prepared in a double weave process in which the spacer fibers are interlaced with one set of warp fibers and one set of filling fibers which form the first fabric layer. The spacer fibers are then interlaced with a second set of warp fibers and filling fibers to form the second fabric layer. The spacer fibers interconnect the first and second fabric layers together.

Spacer fabrics in accordance with the invention can be prepared using conventional methods for preparing such fabrics. For instance, in one embodiment, the spacer fabric can be prepared by knitting a three-dimensional knit fabric on a double-needle bar warp knitting machine, such as a Raschel warp knitting machine. Generally, double needle bar Raschel warp knitting machines are equipped with two independently operated needle bars fed with multiple warps of yarn from a plurality of respective warp beams through a corresponding plurality of yarn guide bars. In one embodiment, the spacer fabric can be prepared from five or more sets of fibers separately wound on individual warp beams and fed to the two needle bars through a corresponding set of yarn guide bars, normally with at least two sets of fibers fed through two corresponding guide bars exclusively to one of the needle bars to fabricate one of the fabric layers, at least two other sets of fibers fed through other corresponding guide bars exclusively to the other needle bar to fabricate the other fabric layer, and the remaining sets of fibers (i.e., spacer fibers) fed through one or more of the remaining available guide bars alternately to the two needle bars to extend between and interknit with the two fabric layers and thereby to interconnect and maintain the fabric layers in a spaced-apart essentially parallel relation. In a further embodiment, the spacer fabric can be prepared using a double needle bar Raschel warp knitting machines having 2 warp beams and three guide bars.

Spacer fabrics in accordance with the invention can comprise weft knit fabrics including circular knit fabrics, filling knit fabrics, flat knit fabrics and the like. Weft knit fabrics can be formed on circular and flat bed knitting machines. In one embodiment, the spacer fabric is formed from flame resistant fibers that are interlooped to form the first and second fabric layers. The flame resistant spacer fibers may also be interlooped with the flame resistant fibers of the fabric layers to form the spacer fabric.

The size of the fibers of the first and second fabric layers are typically selected based on the desired level of heat and flame resistance of the spacer fabric, and the desired comfort, stiffness, and drapeability of the spacer fabric. For example, in apparel and protective garment applications the fibers comprising the fabric layer generally have a size between about 20 to 600 denier, and in particular from about 20 to 400 denier. In one particular embodiment, the fibers comprising the fabric layer generally have a size between about 80 to 200 denier. In structural and industrial applications, the fibers comprising the fabric layer generally have a size between about 100 to 4,000 denier, and in particular from about 200 to 2,000 denier.

Suitable flame resistant materials for the wrap fibers and first and second fabric layers may include aramids, flame resistant cellulose rayon including flame resistant viscose rayon, such as polynosic rayon, flame resistant cotton, flame resistant cuprammonium, flame resistant lyocell, flame resistant modal, flame resistant poly-lactic acid, flame resistant polyester, polybenzimidazole, polyvinyl alcohol, polytetrafluoroethylene, flame resistant wool, poly(vinyl chloride), polyetheretherketone, polyetherimide, polyethersulfone, polychlal, polyimide, polyamide, polyimide-amide, polyolefin, polybenzoxazole, flame resistant acetone, carbon, graphite modacrylic, acrylic, melamine, polyoxodiazole and combinations thereof. In one particular embodiment, the wrap fibers and the first and second fabric layers is formed from a flame resistant material such as Kevlar® or Nomex® fibers. A particularly useful flame resistant fiber that may be used in the practice of the invention is described in U.S. patent application Ser. No. 11/389,783, entitled “FLAME RETARDANT TEXTILE FABRIC”, the contents of which is hereby incorporated by reference in its entirety. The wrap fibers can be made of either the same or a different material from that of the first and second fabric layers. In one embodiment, the wrap fibers and the fibers of the first and second layers comprise flame materials, such as aramids and flame resistant cellulose fibers including cotton and viscose.

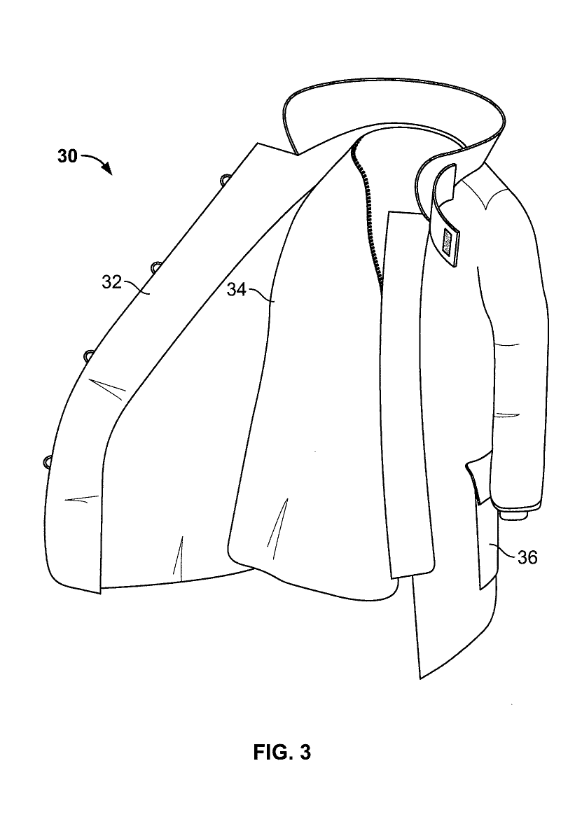

The flame resistant spacer fabric of the present invention can be used to construct or form thermal/flame protective garments, such as a firefighters' turn-out coat, pants, face shield, head-covering, gloves, one-piece coverall, race car driver jump suits, and the like. With reference to FIG. 3 of a fireman's coat constructed in accordance with an embodiment of the present invention is illustrated and broadly designated as reference number 30. Fireman's coat 30 comprises an outer coat portion 32 which forms an outer shell and an inner coat portion 34 that forms a detachable liner for the outer shell. The inner liner 34 typically comprises a thermal insulation material and the outer coat portion 32 is typically formed from the flame resistant spacer fabric of the present invention. The present invention can also be used to form either layer of the garment and also can be used to form single layer garments and other types of garments. In one embodiment, the coat 30 may also include one or more pockets 36 disposed on opposite sides of the coat.

The spacer fabric of the invention can also be used to prepare flame resistant fabrics for numerous applications, such as upholstery, mattress and pillow ticking, mattress pads, bed spreads, pillow covers, draperies or cubicle curtains, wall-coverings, window treatments, and the like.

Spacer fabrics in accordance with the invention can also be used in a wide variety of industrial and/or structural applications. For example, the spacer fabric can be used in heat shield applications, insulation applications, such as thermal insulation for automotive use, e.g., for insulating engine compartment, components, hoses and the like, as well as fabric structures including architectural applications. The spacer fabric may also be used in body armor applications.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A flame resistant spacer fabric comprising:
at least a first and second fabric layers arranged in opposing back-to-back relation
and spaced apart from each other, the first and second fabric layers comprising a flame resistant material; and
one or more spacer fibers interconnecting the first and second fabric layers and defining a space therebetween, the spacer fibers comprising at least one core fiber having one or more wrap fibers of a flame resistant material wrapped thereabout.

2. The flame resistant spacer fabric of claim 1, wherein the first and second layers each include an inner surface and wherein the spacer fibers are generally oriented at an average angle of about 45° to 135° with respect to the inner surfaces.

3. The flame resistant spacer fabric of claim 1, wherein the distance between the first and second fabric layers is at least about 1 mm.

4. The flame resistant spacer fabric of claim 1, wherein the distance between the first and second fabric layers is between about 2 to 8 mm.

5. The flame resistant spacer fabric of claim 1, wherein the core fiber comprises a monofilament comprising polyester, nylon, acrylic, polypropylene, or a combination thereof.

6. The flame resistant spacer fabric of claim 1, wherein the flame resistant wrap fibers comprise aramids, flame resistant viscose rayon, flame resistant cotton, flame resistant polyester, polybenzimidazole, polyvinyl alcohol, polytetrafluoroethylene, flame resistant wool, poly(vinyl chloride), polyetheretherketone, polyetherimide, polyethersulfone, polychlal, polyimide, polyamide, polyimide-amide, polyolefin, polybenzoxazole, flame resistant acetone, carbon, graphite modacrylic, acrylic, melamine, polyoxodiazole, and combinations thereof.

7. The flame resistant spacer fabric of claim 1, wherein the flame resistant wrap fibers comprise rayon, cuprammonium, lyocell, modal, viscose, cotton, aramid, or combinations thereof.

8. The flame resistant spacer fabric of claim 1, wherein the first and second layer comprise aramids, flame resistant viscose rayon, flame resistant cotton, flame resistant polyester, polybenzimidazole, polyvinyl alcohol, polytetrafluoroethylene, flame resistant wool, poly(vinyl chloride), polyetheretherketone, polyetherimide, polyethersulfone, polychlal, polyimide, polyamide, polyimide-amide, polyolefin, polybenzoxazole, flame resistant acetone, carbon, graphite modacrylic, acrylic, melamine, polyoxodiazole and combinations thereof.

9. The flame resistant spacer fabric of claim 1, wherein the core fibers are wrapped with two or more of wrap fibers disposed in a side-by-side or counter-wrapped relation.

10. The flame resistant spacer fabric of claim 1, wherein the spacer fiber comprises a core fiber having two or more layers of wrap fibers wrapped thereabout.

11. The flame resistant spacer fabric of claim 1, wherein the spacer fabric comprises at least one layer in a protective garment.

12. The flame resistant spacer fabric of claim 11, wherein the protective garment comprises a coat.

13. The flame resistant spacer fabric of claim 11, wherein the protective garment comprises a race driver's jump suit.

14. A flame resistant spacer fabric comprising:
at least a first and second fabric layers disposed opposite each other in a back-to-back relationship, the first and second fabric layers each comprising a double weave fabric formed of at least one set of flame resistant warp fibers and at least one set of filling fibers which are interlaced with each other to form each respective fabric layer; and
one or more spacer fibers that are interlaced with the set of warp and filling fibers on each fabric layer to thereby interconnect the first and second fabric layers and to define a space therebetween, the spacer fibers comprising at least one core fiber having one or more wrap fibers of a flame resistant material wrapped thereabout, and wherein the at least one core fiber is heat and flame sensitive.

15. The spacer fabric of claim 14, wherein the core fiber comprises a multifilament.

16. The spacer fabric of claim 14, wherein the core fiber comprises a monofilament.

17. The spacer fabric of claim 14, wherein the warp fibers and the filling fibers have a size that is from about 20 to 400 denier.

18. The spacer fabric of claim 14, wherein the spacer fibers have a size that is from about 30 to 500 denier.

19. The spacer fabric of claim 14, wherein the core fiber comprises a monofilament and the wrap fiber comprise flame viscose rayon.

20. A flame resistant spacer fabric comprising:
a weft knitted fabric having at least a first and second fabric layers arranged opposite each other in opposing back-to-back relation and spaced apart from each other, the first and second fabric layers comprising a plurality of interlooped flame resistant fibers; and
one or more spacer fibers interconnecting the first and second fabric layers and defining a space therebetween, the spacer fibers comprising at least one core fiber having one or more wrap fibers of a flame resistant material wrapped thereabout.

21. The spacer fabric according to claim 20, wherein the fabric comprises a circular knit fabric.

22. The spacer fabric according to claim 20, wherein the wrap fibers comprise a flame resistant viscose material having a size of about 50 denier and the core fibers comprises a monofilament having a size of about 30 denier.

23. A method of preparing a flame resistant spacer fabric comprising the steps of:
forming a first and second fabric layer from two or more flame resistant fibers;
wrapping one or more wrap fibers about a core fiber to form a spacer fiber, the one or more wrap fibers comprising a flame resistant material;
positioning the first and second fabric layers in a spaced-apart relation; and
interlacing the spacer fiber through the first and second layers to interconnect the first and second layer and define a space therebetween.

24. The method of claim 23, wherein the spacer fiber is interlaced with the first and second fabric layers during the step of forming the first and second fabric layer.

25. The method of claim 23, wherein the step of forming the first and second fabric layers comprises interweaving the two or more flame resistant fibers.

26. The method of claim 23, wherein the step of forming the first and second fabric layers comprises weft-knitting the two or more flame resistant fibers.

27. The method of claim 26, wherein the spacer fabric comprises a circular knit fabric.
